(19) United States
(12) Patent Application Publication
(10) Pub. No.: US 2005/0011285 A1
(43) Pub. Date: Jan. 20, 2005

(54) Wide total pressure range probe with hemi-spherical tip

(76) Inventor: Igor Giterman, Woodbridge, CT (US)

Correspondence Address: ST. ONGE STEWARD JOHNSTON & REENS, LLC, 986 BEDFORD STREET, STAMFORD, CT, 06905-5619, US

(21) Appl. No.: 10/620,393

(22) Filed: Jul. 16, 2003

(51) Int. Cl. G01F 1/46

(52) U.S. Cl. 73/861.65

(57) ABSTRACT

A highly reliable air data pressure probe having an accurate, sensitive and linear Angle of Attack and Angle of Sideslip measurement, while simultaneously providing for an increased range of and increased accuracy of total air pressure measurements while further ensuring proper de-icing and anti-icing of the air data pressure probe.

### FIELD OF THE INVENTION

An air data pressure probe that provides high accuracy, sensitivity and linearity to Angle of Attack and Angle of Sideslip measurements while simultaneously facilitating an increased range of insensitivity for and accurate measurement of total air pressure.

### BACKGROUND OF THE INVENTION

Air data pressure probes are utilized in aircraft to sense air pressure. A number of particularly important pressure readings are, for instance, total air pressure (“Pₜ”), Angle of Attack (“AOA”), and Angle of Sideslip (“AOS”). Accurate Pₜ, AOA and AOS readings may be affected by many variables. For instance, if the aircraft is diving or climbing (AOA), banking or sliding to the right or left (AOS), or any combination of the forgoing, these actions will affect the accuracy of the Pₜ, AOA and AOS readings of the air data pressure probe. In addition, various head, tail and cross winds, or any combination thereof may also affect the accuracy of the Pₜ, readings of the air data pressure probe.

Various probes have been utilized for measuring pressure on aircraft for many years. It appears that the use of conical inlet ports for aircraft pressure sensors are known, and the use of pressure sensors employing a hemispherical nose section is also known.

One particular probe that has been widely used has a conical tip section having a tapered or slightly curved housing. This configuration is noted for exhibiting characteristics such as having a wide range of insensitivity to AOA and AOS. In addition, flash mount ports have been widely used for measuring static pressure in this configuration. In an attempt to provide greater accuracy and sensitivity to AOA and AOS measurements, various versions of air data pressure probes have utilized multi-port tip configurations. These attempts to increase AOA and AOS measurements have proved moderately successful, however an air data pressure probe comprising a single, simple unit that provides even greater accuracy, sensitivity and linearity is highly desirable. A further inherent problem with air data pressure probes with conical tip sections having tapered inlets is that it is very difficult to locate heaters for de-icing or anti-icing close to the tip section and the inlet port. Conical tip sections having tapered housings also having lower de-icing or anti-icing efficiency because heat conductivity through a tapering cross section is relatively poor. As a result, these air data pressure probes have been less reliable due to build up of ice at the tip section in the inlet port.

Alternatively, air data pressure probes having a hemispherical tip configuration have also been utilized. Air data pressure probes having a hemispherical tip configuration may provide some significant advantages. For instance, hemispherical tipped probes provide high sensitivity and excellent linearity for measuring AOA and AOS. However, a major problem with this configuration is that hemispherical tipped probes also have been relatively inaccurate for measuring total pressure. Hemispherical tipped probes when utilized with conventional inlet ports have had a relatively small range (AOA and AOS) of insensitivity for Pₜ measurement, which is unacceptable.

A number of patents have issued for air data pressure probes, however, none have addressed and dealt with this problem.

For instance, U.S. Pat. No. 3,585,859 to De Leo et al. (“the '859 patent”) discloses a strut-mounted static pressure tube having a port. It appears that the '859 patent discloses the use of a conical opening for the inlet port with a tapered housing. This configuration may prove accurate for total pressure measurements, but will however be unacceptably inaccurate and insensitive to measurement of AOA and AOS because of the tapered housing that is utilized. This configuration will also prove less reliable due to lower de-icing or anti-icing efficiency because of the shape of both the tip portion and the shape of the tapered body section.

U.S. Pat. No. 3,514,999 to Mejean et al. (“the '999 patent”) also discloses an arrangement for a pitot tube. It appears that the '999 patent, like the '859 patent, discloses the use of a conical opening for the inlet port with a tapered housing. As stated previously, this type of configuration may prove accurate for total pressure measurements, but will however be unacceptably insensitive to measurement of AOA and AOS because of the tapered housing that is used. This configuration also will be have a lower de-icing or anti-icing efficiency due to the shape of the tip portion and the body section.

U.S. Pat. No. 3,482,445 to De Leo et al. (“the '445 patent”) discloses a probe having sections of different diameters and a tapered transition surface section between the sections of different diameters. Again it appears that the inlet port may be conical while the probe comprises a tapered housing. Like both the '859 patent and the '999 patent, the '445 patent may provide for fairly accurate total pressure measurements, but will however be unacceptably insensitive to measurement of AOA and AOS because of the tapered housing that is utilized. Also as stated previously, this type of configuration will have lower de-icing or anti-icing efficiency and therefore prove less reliable.

U.S. Pat. No. 5,025,661 to McCormack (“the '661 patent”) discloses an air data sensor probe having a hemispherical nose section and a central opening for measurement of total pressure along with off-axis openings. However, while hemispherical tipped nose sections generally provide high sensitivity and excellent linearity for measuring AOA and AOS,, the '661 patent is primarily focused on measurement of total temperature and total pressure. ('661 patent Col. 3, lines 14-15) To that end, the '661 patent teaches the use of a cavity with a large, cylindrical forward facing central opening (inlet port) in conjunction with a stagnation chamber such that the probe is insensitive to AOA and AOS. ('661 patent FIG. 1A, 1B and 1C; Col. 3, lines 16-20; Col. 6, lines 10-14 and 23-27) While the large, cylindrical central opening together with the stagnation chamber is designed to provide an accurate total temperature measurement and total pressure measurement, the insensitivity to AOA and AOS measurements that result from this arrangement is unacceptable. In addition, the stagnation chamber required to provide accurate total pressure measurement is very large, thereby increasing the size of the air data pressure probe, which is highly undesirable.

U.S. Pat. No. 4,718,273 to McCormack (“the '273 patent”) discloses an air data sensor probe having a hemispherical nose section and an elongated central opening for measurement of total pressure and a plurality of off-axis openings. Although the '273 patent may provide for a fairly accurate AOA measurement, AOS measurement will be limited. ('273 patent Col. 2, lines 38-42) In addition, because of the configuration of the inlet port, i.e. elongated in the AOA direction and relatively small in the AOS direction, the '273 patent will till have an unacceptably small range of insensitivity for Pₜ measurement and is therefore unacceptable.

While hemispherical nose sections have provided accurate AOA and AOS measurements and conical tipped sections having tapered housings have provided relatively accurate total pressure measurements, these multiple benefits have not been realized in one single air data pressure probe. In fact, both the '273 patent and the '661 patent teach against the use of a hemispherical nose section with conical opening for the inlet port. For instance, the '273 patent teaches that the inlet port must be large in the α (angle of attack) axis and small in the β (angle of yaw) axis (see FIG. 3). ('273 patent Col. 2, lines 43-57) This configuration however, will provide an unacceptably small range of insensitivity for Pₜ measurement, and there are no ports for AOS measurements. Further, the '661 patent also teaches the use of a large, forward facing central opening (inlet port) that is cylindrical for providing an accurate total temperature measurement, however this configuration proves to be insensitive to AOA and AOS which is unacceptable. ('661 patent FIG. 1A, 1B and 1C; Col. 3, lines 16-20; Col. 6, lines 10-14 and 23-27)

Therefore, what is desired is an air data pressure probe that will provide high accuracy, sensitivity and linearity for measurement of both AOA and AOS while simultaneously providing for an increased range for Pₜ measurement.

It is further desired to provide an air data pressure probe that will provide the above-listed benefits while at the same time providing for increased reliability of the probe.

It is further desired to provide an air data sensor probe that will provide high accuracy, sensitivity and linearity for measurement of both AOA and AOS while at the same time not degrade the de-icing or anti-icing efficiency of the probe.

### SUMMARY OF THE INVENTION

These and other objects of the invention are achieved utilization of an air data pressure sensor utilizing a hemispherical tipped portion in conjunction with an inlet port having a larger diameter at the air input end and a smaller diameter at the air output end where the inlet port connects to a central conduit.

While hemispherical tipped probes have been utilized in the past where AOA and AOS are critical measurements, they have traditionally provided and unacceptably small range of insensitivity for Pₜ measurement. Therefore, because of this limitation, hemispherical tipped probes have traditionally not been utilized for Pₜ measurement.

It has been determined however, that use of a hemispherical tipped probe, so as to provide superior AOA and AOS measurements, in conjunction with an inlet port that progressively gets smaller in diameter from the input to output, will greatly extend the range of insensitivity for Pₜ measurement.

In one advantageous embodiment an air data pressure probe is provided comprising a body section, having an end formed as a hemispherical tip portion, and a central conduit, extending longitudinally through the body section toward the hemispherical tip portion. The air data pressure probe further comprises an inlet port, located in the hemispherical tip portion and communicating with said central conduit having an air inlet end and an air outlet end, the inlet port having a longitudinal cross section that is circular, the diameter of the circular cross section of the air outlet end being smaller than the diameter of the circular cross section of the air inlet end.

In another advantageous embodiment an air data pressure probe is provided comprising a body section, having a hemispherical tip portion, and a central conduit, extending through said body section and toward the hemispherical tip portion. The air data pressure probe further comprises an inlet port having an air inlet end, and an air outlet end that connected to the central conduit, said inlet port having a longitudinal cross section that is circular. The air data pressure probe also comprises a heater, located in the hemispherical tip portion, for de-icing the air data pressure probe, where a diameter of the circular cross section of the air outlet end is smaller than a diameter of the circular cross section of the air inlet end such that said inlet port tapers down from the air inlet end toward the air outlet end.

In still another advantageous embodiment a method is disclosed for providing an air data pressure probe comprising the steps of providing a body section and forming an end of the body section as a hemispherical tip portion. The method further comprises the steps of extending a central conduit longitudinally through the body section and providing an inlet port having an air inlet end and an air outlet end in the hemispherical tip portion. The method also comprises the steps of forming the inlet port to have a longitudinal cross section that is circular with a diameter of the circular cross section of the air outlet end being smaller than the diameter of the circular cross section of the air inlet end; and connecting the air inlet end of the inlet port to the central conduit.

The invention and its particular features and advantages will become more apparent from the following detailed description considered with reference to the accompanying drawings.

### BRIEF DESCRIPTION OF THE DRAWINGS

FIG. 1 is an illustration of an advantageous embodiment of the present invention showing the air data pressure probe with a hemispherical tipped portion and a fruso-conical inlet port.

FIG. 2 is an illustration of another advantageous embodiment of the present invention showing the air data pressure probe with a hemispherical tipped portion, a fruso-conical inlet port and heaters for de-icing.

FIG. 3 illustrates a sectional drawing of still another advantageous embodiment of the present invention.

FIG. 4 illustrates a sectional drawing of yet another advantageous embodiment of the present invention.

FIG. 5 illustrates a sectional drawing of still another advantageous embodiment of the present invention.

FIG. 6 is an illustration of yet another advantageous embodiment of the present invention showing the air data pressure probe with a hemispherical tip portion and an inlet port having convex sides.

FIG. 7 is an illustration of yet another advantageous embodiment of the present invention showing the air data pressure probe with a hemispherical tip portion and an inlet port having concave sides.

### DETAILED DESCRIPTION OF THE DRAWINGS

An air data pressure probe has been disclosed that provides high sensitivity to AOA and AOS measurements, while simultaneously providing a highly accurate Pₜ measurement with a greatly extended range of insensitivity. The disclosed air data pressure probe also proves to be more reliable than probes utilizing a tapered body and nose section because heaters may be located closer to the tip to prevent the build up of ice in the inlet port, which would cause the probe to temporarily cease functioning.

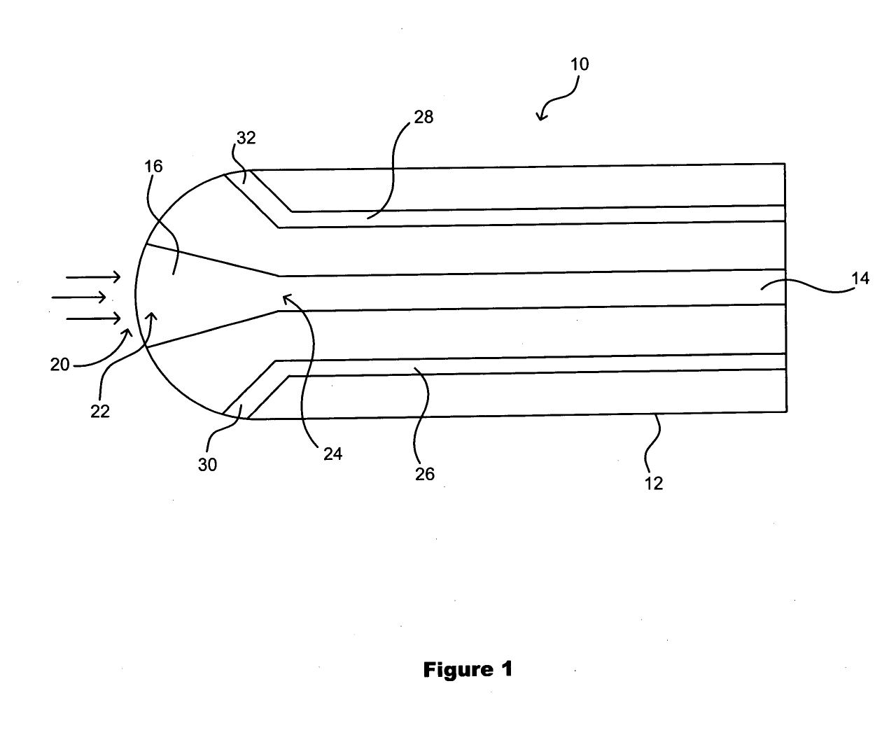

FIG. 1 illustrates one advantageous embodiment of the air data pressure probe 10. Air data pressure probe 10 is provided with an elongated body section 12 and may be made from any suitable substance such as a lightweight alloy, plastic, stainless steel or any thermally conductive metal such as beryllium-copper or copper. Elongated body section 12 may comprise any desired shape based upon the application. In a preferred embodiment, the cross section of elongated body section 12 is circular. However, the elongated body section 12 may have, but is not limited to a circular cross section, an elliptical cross section, or an angular cross section, which may be selected depending upon the particular use. The elongated body section 12 illustrated in FIG. 1 is further shown having a uniform cross section, however this is not necessary. For instance, the cross section of the elongated body section 12 may taper slightly from the distal end to the proximal end if this is desired.

The distal end portion 20 of the elongated body section 12 is provided as a hemispherical tipped portion. Having a hemispherical tipped portion is advantageous because it provides highly accurate AOA and AOS accuracy, sensitivity and linearity. The diameter of the distal end portion 20 however, may vary depending upon the application.

A central conduit 14 is also provided in air data pressure probe 10. As depicted in FIG. 1, the central conduit 14 is located in and extends longitudinally through the elongated body section 12. The central conduit 14 comprises any suitable shape based upon the intended application although in a preferred embodiment, central conduit 14 comprises a circular cross section.

Inlet port 16 is provided at distal end portion 20 of air data pressure probe 10. As shown in FIG. 1, inlet port 16 is located in the hemispherical tipped portion of the elongated body section 12. The inlet port 16 is further provided with an air input end 22, which is located at the extreme distal end portion 20 of air data pressure probe 10, and with an air output end 24 that is connected to an communicates with central conduit 14.

Inlet port 16 is provided such that it comprises a larger diameter at air input end 22 and a smaller diameter at the air output end 24 where inlet port 16 connects to central conduit 14. It should be noted that although inlet port 16 in FIG. 1 is illustrated as, for instance, a frusto-conical section, inlet port 16 might take a number of differing shapes. For instance, inlet port 16 may comprise a section having a larger diameter at air input end 22 and a smaller diameter at the air output end 24 and having concave or alternatively, convex sides. However, it should also be noted that a longitudinal cross section view of inlet port 16 would always be circular although the diameter may vary. Having a circular cross section will contribute to the desired increase in accuracy for Pₜ measurement.

It has been determined that the forming of inlet port 16 such that air input end 22 has a larger diameter than air output end 24 which is combined with a hemispherical tipped portion of the elongated body section 12, results in an extended range of insensitivity for Pₜ measurement.

Conduits 26 and 28 are also provided in air data pressure probe 10. As shown in FIG. 1, conduits 26 and 28 are located in and extend longitudinally through elongated body section 12. Preferably, conduits 26 and 28 are placed equidistant apart from central conduit 14. Conduits 26 and 28 comprise a generally circular cross section. The diameter of conduits 26 and 28 are also generally smaller than the diameter of central conduit 14. Conduits 26 and 28 are each connected to inlet ports 30 and 32 respectively. As depicted in FIG. 1, inlet ports 30 and 32 are offset from the inlet port 16 and are located along the hemispherical tipped portion of the elongated body section 12. While inlet ports 30 and 32 may comprise conduits having a constant inside diameter, such as illustrated in FIG. 1, inlet ports 30 and 32 may also be formed in the same manner as inlet port 16, namely having an air input end that has a larger diameter than the air output end.

Inlet ports 30 and 32 allow for greater accuracy, sensitivity, and linearity for measurement of AOA and AOS depending upon which quadrants they are located in when viewed in cross section.

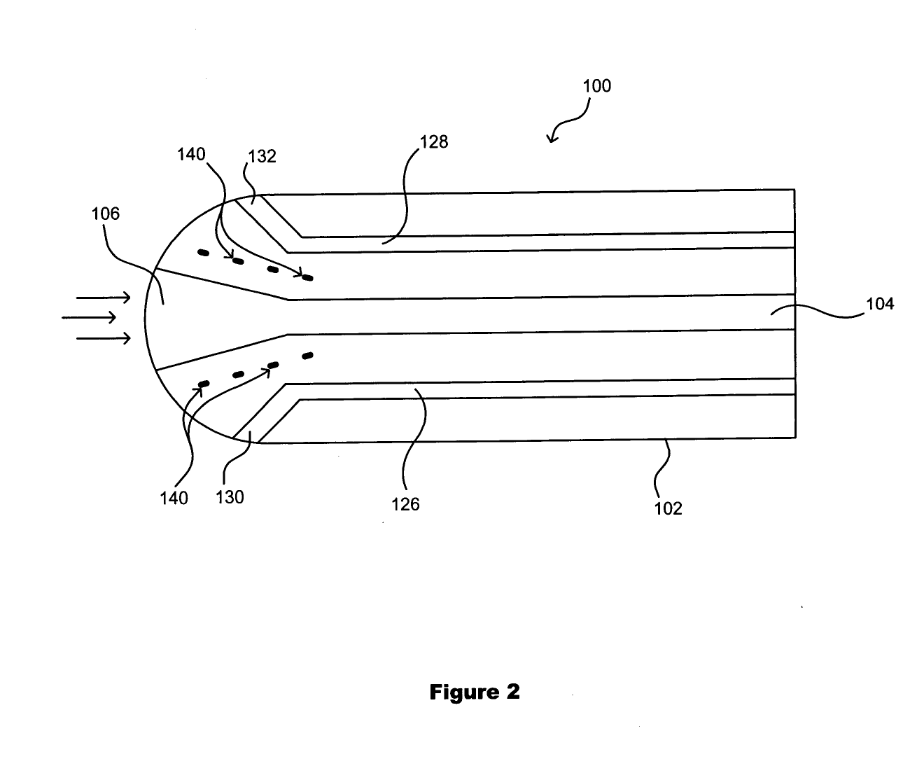

FIG. 2 illustrates another advantageous embodiment of the present invention. Air data pressure probe 100 is shown having many of the features as previously described in FIG. 1. An elongated body section 102 is provided having a central conduit 104, which is connected to an inlet port 106. In addition, conduits 126 and 128, each having inlet ports 130 and 132 respectively are provided as shown in FIG. 2. As the functioning of these various elements are similar to that described in FIG. 1, they will not be described again.

Also provided in FIG. 2 are heaters 140, which are illustrated schematically and can be, for instance, cubic heaters or cartridge heaters. As illustrated in FIG. 2, it is advantageous to place heaters 140 very near the tip of air data pressure probe 100. This is preferable because ice has a tendency to build up in and around inlet port 106. Ice build up is undesirable because if inlet port 106 becomes partially blocked or fully blocked, this will introduce errors in the Pₜ measurement or the probe may even temporarily cease functioning. It is also preferable to place heaters 140 in a tight pattern around the inlet port 106 so as to facilitate maximum de-icing or anti-icing of inlet port 106.

The hemispherical tipped end section of air data pressure probe 100 facilitates higher efficiency de-icing than in traditional conical tipped probes with tapered housings. This is the case because heat conductivity through a tapering cross section is relatively poor and it is very difficult to locate heaters 140 very near inlet port 106 because of limited space. Furthermore, there simply is not enough space in traditional conical tipped probes with tapered housings to locate heaters 140 in and around inlet port 106. Therefore, much greater de-icing efficiency and operating reliability are achieved with the hemispherical tipped end portion.

Heaters 140 may comprise any heaters as are commonly used in air data pressure probes. For instance, heaters 140 may comprise but are not limited to, resistive type heaters and metal core heaters with or without temperature control, positive temperature coefficient controlled heaters, or solid-state heaters. A source of electrical power (not shown) and electrical conductors (not shown) are utilized to power heaters 140 in a conventional manner.

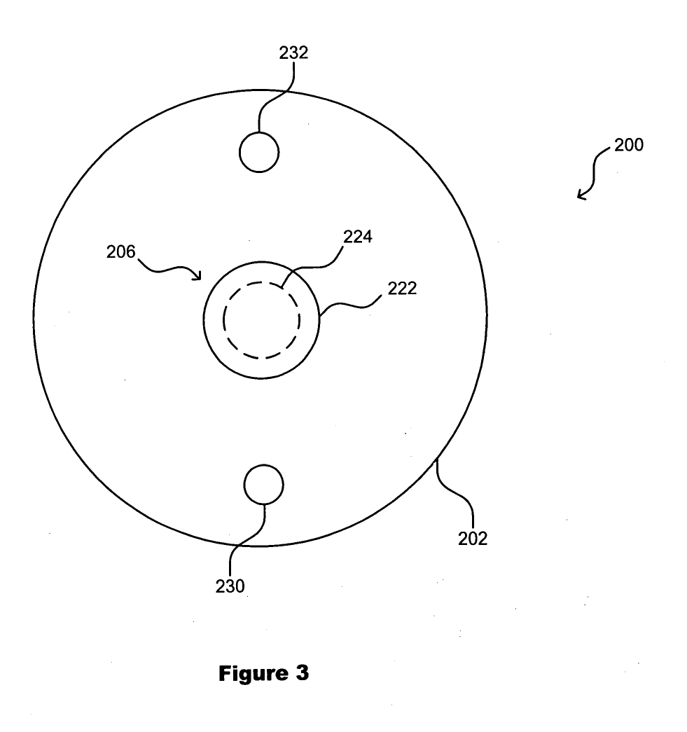

FIG. 3 illustrates still another advantageous embodiment of the present invention. Air data pressure probe 200 is illustrated in a perspective view looking toward the distal end into inlet port 206. Elongated body section 202 is provided which terminates into a curved or rounded end portion. As seen in FIG. 3, inlet port 206 is located in the center of the rounded end portion.

As can also be seen from FIG. 3, inlet ports 230 and 232 are located in the hemispherical tipped end portion and are equally spaced apart from one another and are displaced vertically from and on opposite sides of inlet port 206. This particular placement of inlet ports 230 and 232 will facilitate accurate and sensitive AOA measurements.

Inlet port 206 is illustrated in FIG. 3 as a series of concentric circles. The outer circle represents air input end 222, while the inner circle (dashed line) represents air output end 224 that connects to the central conduit (not shown). Inlet port 206 may, in one particular advantageous embodiment, be a frusto-conical section. In other advantageous embodiments, inlet port 206 comprises air input end 222 that has a first diameter and air output end 224 that has a second diameter, where the first diameter is smaller than the second diameter and where the sides of inlet port 206 have concave or alternatively, convex sides.

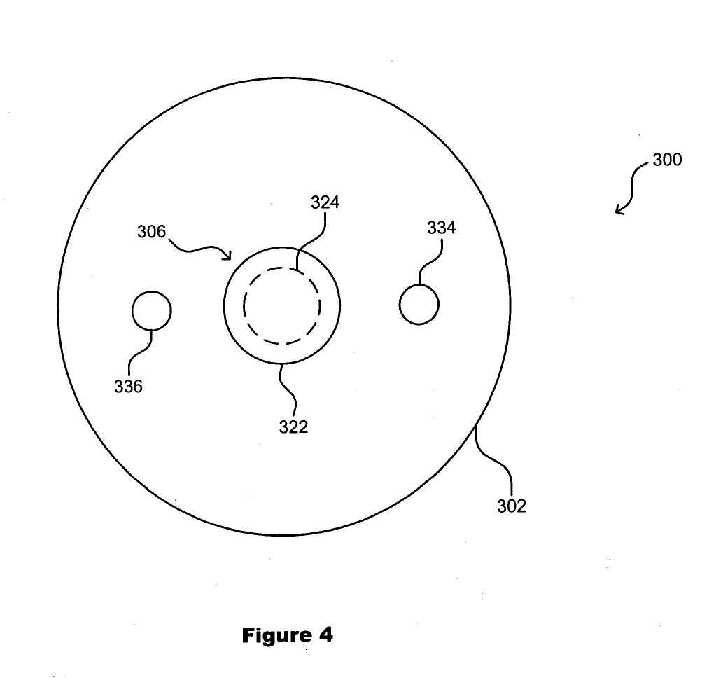

FIG. 4 illustrates yet another advantageous embodiment of the present invention. Air data pressure probe 300 is illustrated in a perspective view looking toward the distal end into inlet port 306. Elongated body section 302 is provided which terminates into a hemispherical tipped end portion. Inlet port 306 is located in the center of the hemispherical tipped end portion as illustrated in FIG. 4.

FIG. 4 further illustrates inlet ports 334 and 336, located in the hemispherical tipped end portion. Inlet ports 334 and 336 are shown equally spaced apart from each other and horizontally displaced from and on opposite sides of inlet port 306. This alternative placement of inlet ports 334 and 336 will facilitate accurate and sensitive AOS measurements.

Inlet port 306 is similar to that described in FIG. 3, the description of which will not be repeated for FIG. 4.

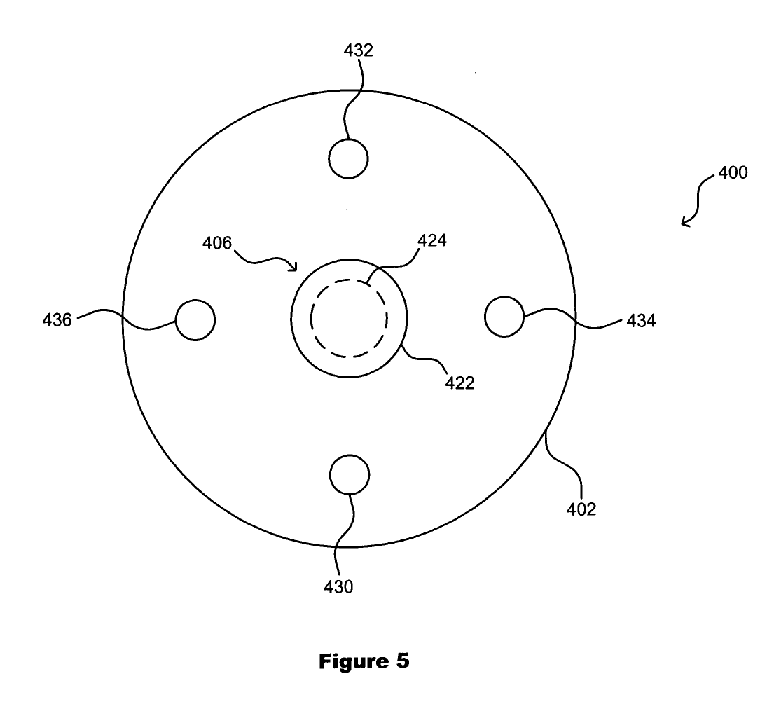

FIG. 5 illustrates yet another advantageous embodiment of the present invention. Here, air data pressure probe 400 is illustrated in a perspective view looking toward the distal end into inlet port 406. Elongated body section 402 is also provided, which terminates into a curved or rounded end portion. Inlet port 406 is located in the center of the rounded end portion as depicted in FIG. 5.

FIG. 5 further depicts multiple sets of inlet ports; 430 and 432; and 434 and 436; all of which are located in the hemispherical tipped end portion. The first set of inlet ports 430 and 432 are similar to those shown in FIG. 3, being equally spaced apart from one another and are displaced vertically from and on opposite sides of inlet port 406. The second set of inlet ports 434 and 436 are similar to those shown in FIG. 4, being equally spaced apart from one another and are displaced horizontally from and on opposite sides of inlet port 406. These particular placements of sets of inlet ports; 430 and 432; and 434 and 436; will provide accurate and sensitive measurements for both AOA and AOS. Although the sets of inlet ports; 430 and 432; and 434 and 436; are shown in vertical and horizontal planes respectively, with respect to inlets port 406, these locations may be varied. For instance, in one advantageous embodiment, inlet ports; 430 and 432; and 434 and 436; may each be rotated 45 degrees (clockwise or counterclockwise) and still provide accurate AOA and AOS measurements. Alternatively, inlet ports; 430 and 432; and 434 and 436; may each be rotated any number of degrees (clockwise or counterclockwise) desired for the particular application.

Inlet port 406 is similar to that described in FIG. 3, the description of which will not be repeated for FIG. 5.

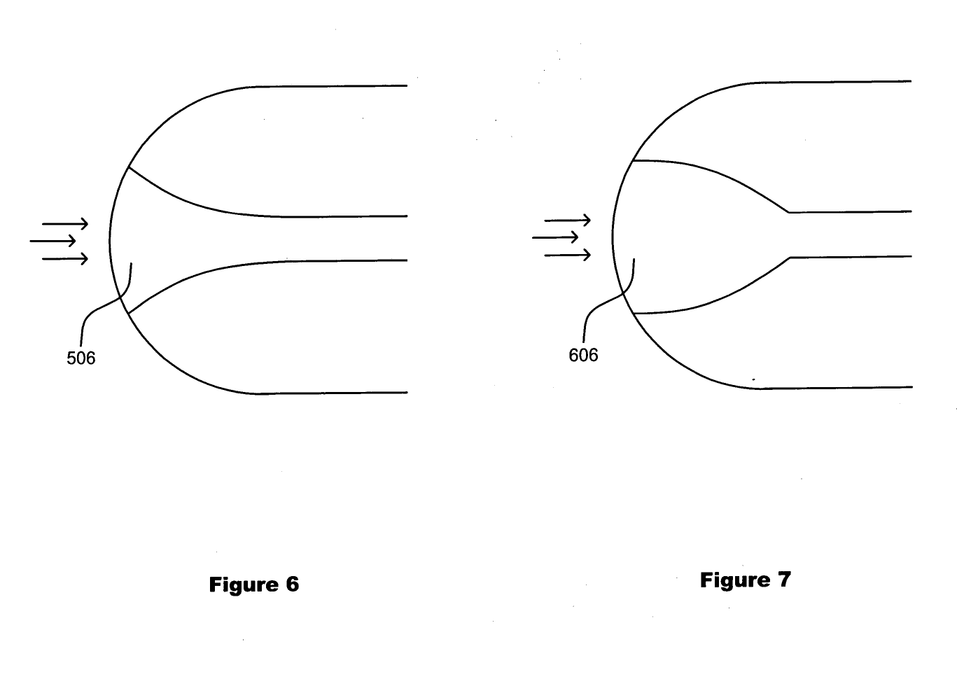

FIG. 6 illustrates still another advantageous embodiment of an inlet port according to the present invention. Inlet port 506 differs from that illustrated in FIG. 1 in that, rather than being frusto-conical, the sides of inlet port 506 are convex. It should be noted however that, a longitudinal cross section view of inlet port 506 would always be circular although the diameter may vary. The

Although not depicted in FIG. 6, heaters (not shown) may also be located in and around inlet port 506 as described in FIG. 2. This will further increase the de-icing efficiency and also the reliability of the probe.

FIG. 7 illustrates yet another advantageous embodiment of an inlet port according to the present invention. Inlet port 606 differs from that illustrated in FIG. 6 in that, rather than being convex, the sides of inlet port 606 are concave. It should be noted however that, just as in FIG. 6, a longitudinal cross section view of inlet port 606 would always be circular although the diameter may vary.

Although not depicted in FIG. 7, heaters (not shown) may also be located in and around inlet port 606 as described in FIG. 2, which will increase the de-icing efficiency and also the reliability of the probe.

Although the invention has been described with reference to a particular arrangement of parts, features and the like, these are not intended to exhaust all possible arrangements or features, and indeed many other modifications and variations will be ascertainable to those of skill in the art.

1. An air data pressure probe comprising:
a body section, having an end formed as a hemispherical tip portion;
a central conduit, extending longitudinally through said body section toward the hemispherical tip portion; and
an inlet port, located in the hemispherical tip portion and communicating with said central conduit having an air inlet end and an air outlet end, said inlet port having a longitudinal cross section that is circular, the diameter of the circular cross section of the air outlet end being smaller than the diameter of the circular cross section of the air inlet end.

2. The air data pressure probe of claim 1 wherein said inlet port is formed as a frusto-conical section.

3. The air data pressure probe of claim 1 wherein said inlet port further comprises convex side portions extending from the air inlet end to the air outlet end.

4. The air data pressure probe of claim 1 wherein said inlet port further comprises concave side portions extending from the air inlet end to the air outlet end.

5. The air data pressure probe of claim 1 further comprising a heater for de-icing the air data pressure probe.

6. The air data pressure probe of claim 5 wherein said heater is located in the hemispherical tip portion.

7. The air data pressure probe of claim 5 wherein said heater surrounds said inlet port.

8. The air data pressure probe of claim 1 further comprising at least two conduits each conduit being located on opposite sides of the central conduit and each conduit having a respective inlet port.

9. The air data pressure probe of claim 8 wherein the respective inlet ports of said at least two conduits are located in the hemispherical tip portion.

10. An air data pressure probe comprising:
a body section, having a hemispherical tip portion;
a central conduit, extending through said body section and toward the hemispherical tip portion;
an inlet port having an air inlet end, and an air outlet end that connected to said central conduit, said inlet port having a longitudinal cross section that is circular; and
a heater, located in the hemispherical tip portion, for de-icing the air data pressure probe;
wherein a diameter of the circular cross section of the air outlet end is smaller than a diameter of the circular cross section of the air inlet end such that said inlet port tapers down from the air inlet end toward the air outlet end.

11. The air data pressure probe of claim 10 wherein said inlet port is formed as a frusto-conical section.

12. The air data pressure probe of claim 10 wherein said inlet port further comprises convex side portions extending from the air inlet end to the air outlet end.

13. The air data pressure probe of claim 10 wherein said inlet port further comprises concave side portions extending from the air inlet end to the air outlet end.

14. The air data pressure probe of claim 10 further comprising at least two conduits each conduit being located on opposite sides of the central conduit and each conduit having a respective inlet port.

15. The air data pressure probe of claim 14 wherein the respective inlet ports of said at least two conduits are located in the hemispherical tip portion.

16. A method for providing an air data pressure probe comprising the steps of:
providing a body section;
forming an end of the body section as a hemispherical tip portion;
extending a central conduit longitudinally through the body section;
providing an inlet port having an air inlet end and an air outlet end in the hemispherical tip portion;
forming the inlet port to have a longitudinal cross section that is circular with a diameter of the circular cross section of the air outlet end being smaller than the diameter of the circular cross section of the air inlet end; and
connecting the air inlet end of the inlet port to the central conduit.

17. The method of claim 16 wherein said inlet port is formed as a frusto-conical section.

18. The method of claim 16 wherein said inlet port further comprises convex side portions extending from the air inlet end to the air outlet end.

19. The method of claim 16 wherein said inlet port further comprises concave side portions extending from the air inlet end to the air outlet end.

20. The method of claim 10 further comprising the step of locating a heater in the hemispherical tip portion of the air data pressure probe for de-icing.

21. The method of claim 10 further comprising the steps of:
locating at least two conduits opposite each other and on opposite sides of the central conduit; and
providing a respective inlet port for each conduit in the hemispherical tip portion of the air data pressure probe.
